(19) United States
(12) Patent Application Publication
(10) Pub. No.: US 2009/0152326 A1
(43) Pub. Date: Jun. 18, 2009

(54) ULTRASONIC WELDING-BASED MICROFLUIDIC DEVICE AND METHOD OF MANUFACTURING THE SAME

(75) Inventors: Dong Ho SHIN, Daejeon (KR); Young Jun Kim, Daejeon (KR); Min Suk Jeong, Jeongeup (KR); Sang Hee Kim, Daejeon (KR); Hye Yoon Kim, Daejeon (KR); Moon Youn Jung, Daejeon (KR); Seon Hee Park, Daejeon (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon (KR)

(21) Appl. No.: 12/142,712

(22) Filed: Jun. 19, 2008

(30) Foreign Application Priority Data
Dec. 17, 2007 (KR) 10-2007-132321

(51) Int. Cl. B23K 20/10; B23K 1/06

(52) U.S. Cl. 228/110.1; 228/1.1

(57) ABSTRACT

A method of manufacturing an ultrasonic welding-based microfluidic device, the method including: forming a bottom board having two welding stoppers formed right and left and having a certain height and a certain interval; forming a top board having two energy directors formed with an interval greater than the interval between the two welding stoppers; putting the top board on the bottom board to locate the energy directors at the outside of welding stoppers, respectively; and welding the top board to the bottom board by using ultrasonic welding, wherein a channel is formed between the two welding stoppers without additional energy directors. Accordingly, it is possible to prevent a phenomenon that a fluid irregularly flows due to an uneven surface formed on a side of the channel while the energy directors are melted.

### CROSS-REFERENCE TO RELATED APPLICATIONS

This application claims the priority of Korean Patent Application No. 2007-0132321 filed on Dec. 17, 2007, in the Korean Intellectual Property Office, the disclosure of which is incorporated herein by reference.

### BACKGROUND OF THE INVENTION

1. Field of the Invention

The present invention relates to an ultrasonic welding-based microfluidic device and a method of manufacturing the same, and more particularly, to a method of manufacturing a microfluidic device for preventing a phenomenon that a fluid irregularly flows due to an uneven surface formed on a side of a channel while an energy director is melted by ultrasonic welding.

The present invention was supported by the IT R&D program of MIC/IITA [2006-S-007-002, titled: Ubiquitous Health Monitoring Module and System Development].

2. Description of the Related Art

Ultrasonic welding is effectively used for plastic-plastic junction, metal-metal junction, or plastic-metal junction. Instantly applying strong ultrasonic energy to a material, a surface of a portion to be bonded is melted and welded. The ultrasonic welding is generally used in industrial fields, which are widely used in fields of hard disks, batteries of mobile phones, and automobile components.

The ultrasonic welding is known as technology with high productivity. When there are energy directors required in welding in a top and bottom structure, it is possible to weld by only pressure and ultrasonic for a short time, without additional surface processing or surface coating process. Accordingly, it is possible to easily construct a mass production system when continuously supplying samples to be welded.

Recently, microfluidic-based biochips and biosensors have been developed using microelectromechanical systems (MEMS) technology based on a semiconductor process. Currently due to rapid development of sensing technology and microfluidic device construction technology, technology capable of satisfying functions required in biochips and biosensors reaches a considerable level.

On the other hand, development of packaging technology of producing one finished product by integrating such technology does not reaches a desired level. A greatest obstacle in developing the packaging technology is that biochips and biosensors use bio materials such as antibodies and enzymes, different from other MEMS devices. Also, a problem occurs in a process of bonding top and bottom boards. Bio materials are sensitive to a temperature change and lose their own functions while exposed to organic solvents. Also, stability with respect to a light source such as ultraviolet is low. Accordingly, to manufacture biochips and biosensors, a processing technique considering properties of bio materials is required.

From this point of view, ultrasonic welding is capable of being performed at a normal temperature without organic solvent, which is used in manufacturing biochips or biosensors based on microfluidic devices. As commercialized chips, chips developed by Biosite Inc. are widely known. A conventional method of forming a channel structure required in a biochip or a biosensor by using ultrasonic welding is shown in FIGS. 1A to 1C.

As shown in FIG. 1A, two welding stoppers 12 having a certain height are formed at a certain interval right and left on a bottom board and energy directors 22 are formed at a certain interval right and left on a top board 20. In this case, the interval between the two energy directors 22 formed on the top board 20 is narrower than the interval between the welding stoppers 12 in such a way that the energy directors 22 are disposed between the two welding stoppers 12 while bonding the top and bottom boards 20 and 10. In this case, applying ultrasonic energy, the energy directors 22 on the top board 20 are instantly melted and hardened, thereby forming a microfluidic device having a channel 30, as shown in FIG. 1B. In this case, the welding stoppers 12 formed on the bottom board 10 stop the top board not to descend anymore. A height of the welding stoppers 12 determines a depth of the channel 30. In this method, the depth of the channel 30 may be determined by controlling the height of the welding stoppers 12 and it is possible to form a channel having a desired depth on a whole surface of the device. Also, a shape of the channel 30 is determined by the energy directors 22 and the welding stoppers 12. In this case, a side of the channel 30, formed by the energy directors 22, does not have an even surface as shown in FIG. 1B. That is, while the energy directors 22 are melted, the energy directors 22 spread right and left. Also, since strong thermal energy is applied of the moment, bubbles may occur while melted. Accordingly, a hardened welded portion does not have an even surface.

However, a best condition may be generated by controlling a strength of ultrasonic energy and a welding time. Since it is required to apply the energy enough to provide a welding strength supporting a junction between the top and bottom boards 20 and 10 not to be separated from each other, it is difficult to reduce the defect by controlling only an ultrasonic welding condition. Also, a fluid has a property of flowing toward a narrower and shallower portion and a rough welded portion formed due to the energy directors 22 form the side of the channel 30, a serious problem occurs while the fluid passes through the channel 30. This phenomenon is caused since the narrower and shallower portion has a capillary force greater than that of a wider and deeper portion. Accordingly, the fluid has a property of flowing the rough portion of the side of the channel 30 rather than a smooth surface, thereby generating an irregular fluid flow.

When allowing the fluid to flow in such general method as described above, the fluid soaks through the welded portion and flows along the energy directors 22 as shown in FIG. 2A or flows inclined to one side as shown in FIG. 2B.

Accordingly, in the case of the microfluidic device manufactured according to the conventional method, it is difficult to form a channel having a certain width and is not suitable for being applied to biochips or biosensors since a flow property of the fluid is not desirable due to a rough surface of the welded portion.

In the case of such ultrasonic welding, theoretically, it is impossible to apply uniform energy to a whole surface of the device. As a size of a device to be manufactured is greater, uniformity of energy is decreased. When the top and bottom boards 20 and 10 are not leveled while pushed by a welder, another nonuniformity of energy occurs. When not leveled by only 1 um, a portion not welded may occur.

To remove a ground of the problem, hitherto, top and bottom boards are as much leveled as possible and a pressure of 500 N or more is applied during welding to reduce a gap between a device and a welder. However, in spite of such efforts, there is a limitation on making a welding degree perfectly uniform.

As shown in FIG. 3A, when an energy director have a height of H and a width of W is used while manufacturing a microfluidic device having a depth of d, the energy director is spread right and left around a vertex thereof as melted. A degree of spreading varies with a ratio H/d between the height of the energy director and the depth of a channel. That is, as a value of H/d is greater, the degrees of spreading becomes greater. Therefore, as shown in FIG. 3B, the channel has a width narrower than an initially designed channel width and the degree of spreading may vary with the channel.

Accordingly, conventionally, it is impossible to prevent forming an irregular surface however a welding condition is accurately controlled. Due to such properties, using the method of manufacturing a microfluidic device, in which a channel is formed by welding an energy director, it is possible manufacture only a device having a channel in a very simple shape such as a straight line. It is difficult to form a channel having a width of 500 um or less.

### SUMMARY OF THE INVENTION

An aspect of the present invention provides a microfluidic device and a method of manufacturing the same, in which a fluidic channel is formed by forming a deep groove along a side of the channel, without additional energy director, to cause a sudden expansion phenomenon to prevent an irregular fluid flow due to an uneven surface of a channel side, formed by an energy director.

According to an aspect of the present invention, there is provided a ultrasonic welding-based microfluidic device including: a bottom board having two welding stoppers formed right and left with a certain height and a certain interval; a top board having two energy directors formed having an interval greater than interval between the welding stoppers, located at each of two welding stoppers, and welded to the bottom board while ultrasonic welding; and a channel formed between the two welding stoppers as the bottom board is bonded to the top board by the ultrasonic welding.

According to another aspect of the present invention, there is provided a method of manufacturing an ultrasonic welding-based microfluidic device, the method including: forming a bottom board having two welding stoppers formed right and left and having a certain height and a certain interval; forming a top board having two energy directors formed with an interval greater than the interval between the two welding stoppers; putting the top board on the bottom board to locate the energy directors at the outside of welding stoppers, respectively; and welding the top board to the bottom board by using ultrasonic welding, wherein a channel, through which a fluid passes, is formed between the two welding stoppers as the top board is welded to the bottom board.

According to an exemplary embodiment of the present invention, there is provided a microfluidic device capable of allowing a sudden expansion phenomenon by forming a deep groove right and left sides of a channel without physical partition on a side surface of the channel, thereby preventing a rough surface of the channel, formed by an energy director melted by ultrasonic welding, and controlling a fluid flow without depending on surface properties of the side surface of the channel.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A to 1C illustrate a conventional method of manufacturing a microfluidic device;

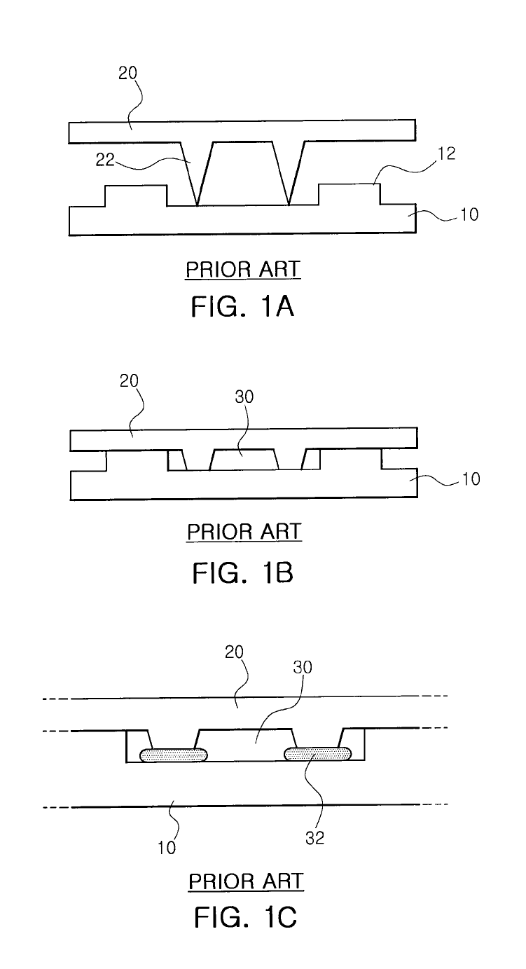

FIGS. 2A and 2B are diagrams illustrating a direction of flow in conventional microfluidic devices;

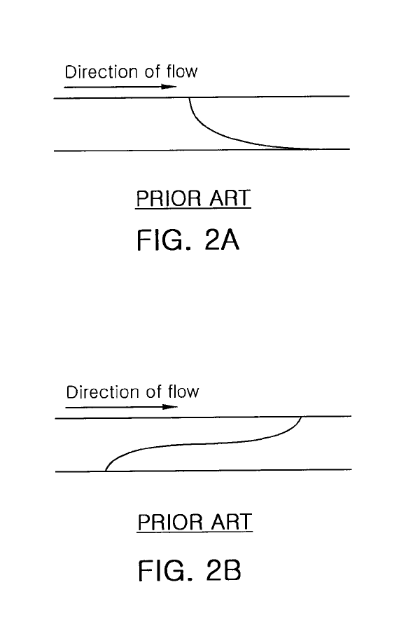

FIGS. 3A and 3B are diagrams illustrating that it is impossible to form a channel having a regular width in conventional microfluidic device;

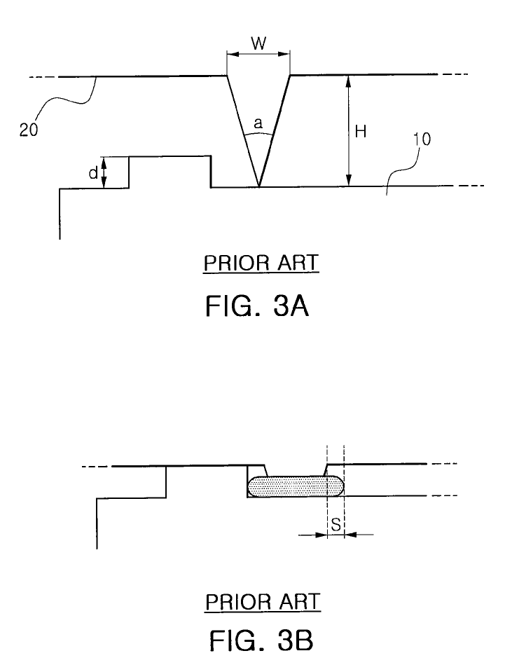

FIGS. 4A to 4C are diagrams illustrating a microfluidic device manufactured according to an exemplary embodiment of the present invention;

FIGS. 5A to 5C are diagrams illustrating a theory of forming a channel without a physical partition in the microfluidic device according to an exemplary embodiment of the present invention; and

FIGS. 6A and 6B are diagrams illustrating a direction of flow in the microfluidic device according to an exemplary embodiment of the present invention.

### DETAILED DESCRIPTION OF THE PREFERRED EMBODIMENT

Exemplary embodiments of the present invention will now be described in detail with reference to the accompanying drawings. Only, in describing operations of the exemplary embodiments in detail, when it is considered that a detailed description on related well-known functions or constitutions unnecessarily may make essential points of the present invention be unclear, the detailed description will be omitted.

A microfluidic device according to an exemplary embodiment of the present invention is manufactured based on ultrasonic welding. The microfluidic device and a method of manufacturing the same will be described in detail with reference to the attached drawings.

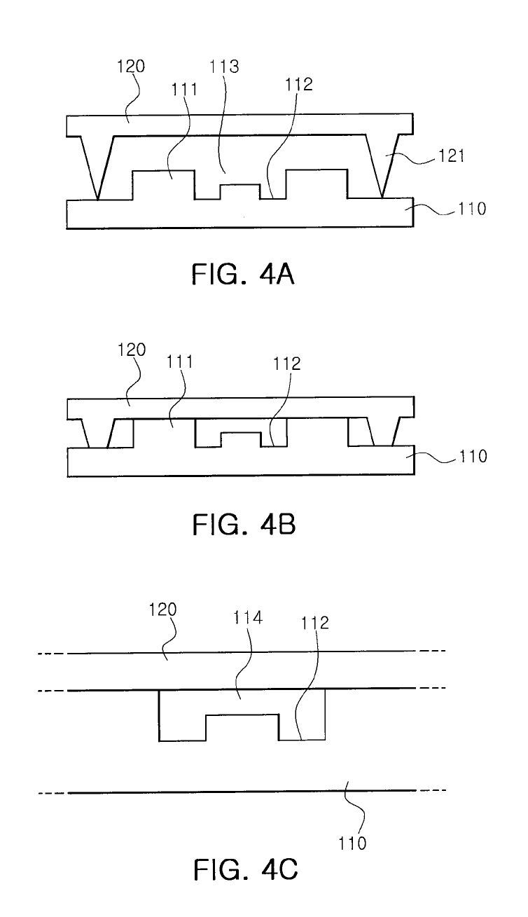

FIGS. 4A to 4C are diagrams illustrating the microfluidic device manufactured according to an exemplary embodiment of the present invention.

As shown in FIG. 4A, the microfluidic device includes a bottom board 110 and a top board and is manufactured as follows to prevent a phenomenon a rough surface of a channel side, formed by an energy director, to make a fluid flow irregular.

Welding stoppers 111 are formed right and left of the bottom board 110 and deep grooves 112 are formed on both sides an area where a channel is formed between the both welding stoppers 111. That is, the deep grooves 112 are formed along the channel side to cause a sudden expansion phenomenon in such a way that a fluid receives a strong fluid resistance from a diagonal direction of a proceeding direction of the fluid and is incapable of flowing out of the channel.

A portion 113 where the channel is formed, on the bottom board 110, may be treated to be hydrophilic. The grooves 112 may be treated to be hydrophobic.

Energy directors 121 are formed on the top board 120, which are formed to be located at the outside of each of the welding stoppers 111 formed on the bottom board 110.

The bottom board 110 and the top board 120 are bonded to each other by ultrasonic welding as shown in FIG. 4B, thereby forming the microfluidic device.

In detail, the top board 120 is put on the bottom board 110 and strong ultrasonic energy is applied to the top board 120 and the bottom board 110 for a very short time such as 0.1 second or less while pressing the top board 120 and the bottom board 110 by a suitable pressure. The applied ultrasonic energy generates a momentary heat to melt the energy director 121 processed to be sharp and formed on a welded portion. Accordingly, the top board 110 and the top board 120 are welded by a material of the melted energy director 121. Since the ultrasonic energy is applied for such very short time, a melted portion allows the top board 120 to adhere to the bottom board 110 as adhesives. In such ultrasonic welding, a temperature transferred to the energy director 121 is 300 degrees or more and rapidly cools down after a rapid temperature increase by 1000 degrees per second. Since most of the applied heat energy is used to melt the energy director 121, there is little temperature increase on a periphery of the welded portion. Accordingly, regardless of using heat for a junction, the ultrasonic welding may be included in a normal temperature process.

When performing the ultrasonic welding as described above, as shown in FIG. 4C, the grooves 112 deeply hollowed along both sides of a shallow channel 114 are formed as channels having a great depth. In this case, an area actually acting as a channel is the shallow channel 114 and the grooves 112 formed on both sides of the channel 114 determine a width of the channel. Accordingly, a packaging of the microfluidic device is formed by the energy directors 121 formed on the periphery of the welding stoppers 111.

A theory of forming the channel 114 by the grooves 112 in the microfluid device manufactured as described above will be described in detail.

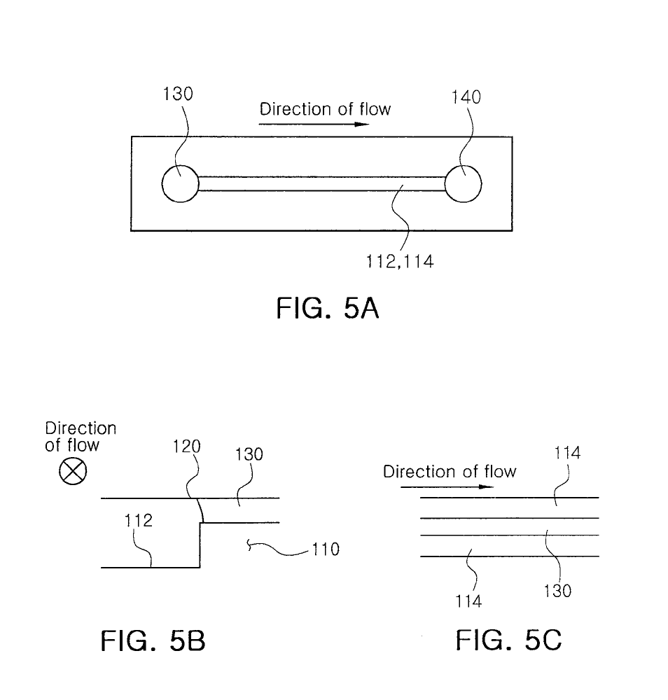

FIGS. 5A to 5C are diagrams illustrating a theory of forming a channel without physical partition in the microfluid device according to an exemplary embodiment of the present invention.

Referring to FIG. 5A, when a fluid is injected via a fluid inlet 130, the fluid meets the deep channels 112 and the shallow 114 at the same time. In this case, since the fluid has a property of flowing along a portion having a greater capillary force, the fluid passes through the shallow channel 114 rather than the deep channels 112. In this case, since the deep channels 112 are formed along the side of the shallow channel 114 and there is no partition therebetween, the fluid may flow into the deep channels 112 from the shallow channel 114. However, when a difference between depths of the channels 112 and the channel 114 is great, the fluid flowing on an edge of the channel 114 goes through a sudden change of a channel depth and there is brought an effect obtained by suddenly increasing a width of the channel. In this case, as shown in FIG. 5B, a fluid flow stops and the fluid injected via the fluid inlet 130 flows along only the shallow channel 114 as shown in FIG. 5C. This phenomenon is called as sudden expansion, which is used to stop a fluid flow at a determined point.

Since the fluid channel formed as described above has no physical boundary, there is no obstacle against a fluid flow, on the channel side. Accordingly, the fluid flow in the channel is determined by surface characteristics of the top and bottom boards 120 and 110 forming the channel and material properties of the fluid.

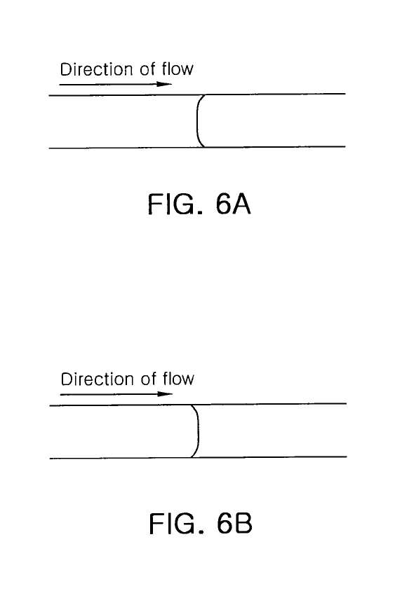

As described above, according to an exemplary embodiment of the present invention, a range of controlling a width and a depth of a channel is wider than that of a conventional method. Also, it is possible to manufacture a microfluidic device having a width of 500 um or less, which is incapable of being manufactured by the conventional method, and it is possible to manufacture a microfluidic device having a width and a depth most similar to designed figures. In the microfluic device manufactured as described above, a fluid flow has uniform fluid characteristics, depending on surface characteristics of top and bottom boards and material properties of a fluid, as shown in FIGS. 6A and 6B.

In addition, it is easy to construct a device having a channel having a desired shape and it is possible to construct a channel structure executing a particular function, such as a stop valve or a time delay valve, in a microfluidic device. The method of manufacturing the microfluidic device may be effectively used in packaging processes for bio chips and bio sensors.

While the present invention has been shown and described in connection with the exemplary embodiments, it will be apparent to those skilled in the art that modifications and variations can be made without departing from the spirit and scope of the invention as defined by the appended claims.

What is claimed is:

1. An ultrasonic welding-based microfluidic device comprising:
a bottom board having two welding stoppers formed right and left with a certain height and a certain interval;
a top board having two energy directors formed having an interval greater than interval between the welding stoppers, located at each of two welding stoppers, and welded to the bottom board while ultrasonic welding; and
a channel formed between the two welding stoppers as the bottom board is bonded to the top board by the ultrasonic welding.

2. The ultrasonic welding-based microfluidic device of claim 1, wherein the bottom board has two grooves deeply hollowed in right and left of the channels between the two welding stoppers.

3. The ultrasonic welding-based microfluidic device of claim 2, wherein the channel comprises deep channels that are two grooves and a shallow channel formed between the two grooves.

4. The ultrasonic welding-based microfluidic device of claim 3, wherein the shallow channel acts as a real channel, and
a width of the channel is determined according to a width of the shallow channel.

5. The ultrasonic welding-based microfluidic device of claim 3, wherein the channel, when a fluid is injected, is suddenly expanded due to a difference between depths of the deep channel and the shallow channel.

6. A method of manufacturing an ultrasonic welding-based microfluidic device, the method comprising:
forming a bottom board having two welding stoppers formed right and left and having a certain height and a certain interval;
forming a top board having two energy directors formed with an interval greater than the interval between the two welding stoppers;
putting the top board on the bottom board to locate the energy directors at the outside of welding stoppers, respectively; and
welding the top board to the bottom board by using ultrasonic welding,
wherein a channel, through which a fluid passes, is formed between the two welding stoppers as the top board is welded to the bottom board.

7. The method of claim 6, further comprising forming two grooves deeply hollowed right and left of the channel formed between the two welding stoppers while forming the bottom board.

8. The method of claim 6, wherein, in the welding the top board to the bottom board, ultrasonic energy is intensively applied to the two energy directors for a short time to melt the two energy directors, thereby welding the top board to the bottom board

9. The method of claim 7, wherein the channel comprises deep channels that are two grooves and a shallow channel formed between the two grooves.

10. The ultrasonic welding-based microfluidic device of claim 9, wherein the shallow channel acts as a real channel, and
a width of the channel is determined according to a width of the shallow channel.

11. The ultrasonic welding-based microfluidic device of claim 9, wherein the channel, when a fluid is injected, is suddenly expanded due to a difference between depths of the deep channel and the shallow channel.
